(19) United States
(12) Patent Application Publication
(10) Pub. No.: US 2026/0063468 A1
(43) Pub. Date: Mar. 5, 2026

(54) FIBER SENSOR FOR DISTRIBUTED ACOUSTIC SENSING BASED ON POLARIZATION DETECTION

(71) Applicant: Xiaotian Steve Yao, Las Vegas, NV (US)

(72) Inventor: Xiaotian Steve Yao, Las Vegas, NV (US)

(21) Appl. No.: 19/318,940

(22) Filed: Sep. 4, 2025

Related U.S. Application Data
(60) Provisional application No. 63/690,633, filed on Sep. 4, 2024.

(51) Int. Cl. G01H 9/00; G01D 5/353; G01J 4/04

(52) U.S. Cl. CPC G01H 9/004; G01D 5/35361; G01J 4/04

(57) ABSTRACT

This patent document discloses designs of distributed acoustic sensing (DAS) fiber sensors that making distributed acoustic sensing measurements using a sensing fiber based on variations over time of the state of polarization of backscattered light returned from the sensing fiber to extract local phase disturbances at various locations along the sensing fiber.

### PRIORITY CLAIM AND RELATED PATENT APPLICATION

This patent document claims priority to and benefits of U.S. Provisional Patent Application No. 63/690,633 entitled “FIBER SENSOR FOR DISTRIBUTED ACOUSTIC SENSING BASED ON POLARIZATION DETECTION” and filed on Sep. 4, 2024, by Xiaotian Steve Yao.

### TECHNICAL FIELD

This patent document relates to optical fiber sensor devices for distributed acoustic sensing (DAS) via a sensing fiber.

### BACKGROUND

Distributed acoustic sensing (DAS) can be used in a wide range of applications, including seismic wave detection, oil exploration, earthquake research, intrusion detection, oil pipeline protection, geophysics observation, infrastructure integrity monitoring, structural fault location, and vehicle tracking, etc.

### SUMMARY

This patent document discloses designs of DAS fiber sensors that making distributed acoustic sensing measurements using a sensing fiber based on variations over time of the state of polarization of backscattered light returned from the sensing fiber to extract local phase disturbances at various locations along the sensing fiber.

In one implementation, an optical sensing device for distributed acoustic sensing using a sensing fiber is provided to include a laser to produce laser light; an optical modulator located to receive the laser light from the laser to produce laser pulses for sensing local phase disturbances at various locations along the sensing fiber to cause scattering of the laser pulses to generate backscattered light; and an optical polarimeter to receive a portion of the backscattered light returned from the sensing fiber to measure Stokes parameters of state of optical polarization of the backscattered light at various locations in the sensing fiber that carry information of variations over time in the state of optical polarization of the backscattered light indicative of the local phase disturbances at various locations along the sensing fiber.

### BRIEF DESCRIPTION OF DRAWINGS

FIGS. 1A-1B shows an example of a first embodiment of the disclosed DAS interrogator for obtaining the sensing signal from the fiber using a high speed polarimeter. A semiconductor laser is used to generate optical pulse going into the sensing fiber by driving the laser with electrical pulses. The backscattered and reflected light from the sensing fiber is separated by an optical circulator from the output light before entering a high speed polarimeter. A disturbance at a location z in the fiber will cause the SOP to change rapidly during the pulse duration, which can be detected by the polarimeter at a time T_{z}=2nz/c, where n is the refractive index of the fiber, as shown in FIG. 1B. The location of the distance can then be determined as z=cT_{z}/(2n).

FIG. 2 shows an example of a second embodiment of the disclosed DAS interrogator for obtaining the sensing signal from the fiber using a high speed polarimter. Laser light is first converted into optical pulse by the modulator/switch and the SOA before output to the sensing fiber. The backscattered and reflected light from the sensing fiber is separated by an optical circulator from the output light before entering a high speed polarimeter. An optional optical amplifier (SOA or EDFA) can be used to amplify the backscattered light before being filtered by an optional BPF to remove the excess spontaneous emission noise. The state of polarization (SOP) of the backscattered light is then then measured with a polarimeter. A disturbance at a location z in the fiber will cause the SOP to change rapidly, which can be detected by the polarimeter at a time T_{z}=2z/(nc), where n is the refractive index of the fiber. The location of the distance can then be determined as z=ncT_{z}/2.

FIGS. 3A-3D show examples of four different wavefront division polarimeters made with micro-optics. a) A polarimeter made with a 2×2 polarizer array placed on the flat side of a wedged substrate, a focusing lens, and a 2×2 photodetector (PD) array. The 2×2 polarizer array includes three different polarizers oriented at 0°, 45°, 90° and a right-hand circular (RHC) or left hand circular (LHC) polarizer. Alternatively, one of the 0° or 90° polarizer can be replaced with a flat optical thin plate. In operation, a fiber collimator expands the input light from an optical fiber before passing through the 2×2 polarizer array to be divided into four sub-beams with different polarizations, and then being directed to four different directions by the wedged substrate. Finally, the four sub-beams are focused to different PDs on the 2×2 PD array to generate corresponding photocurrents or photo-voltages with four transimpedance amplifiers. b) A polarimeter similar to that of a) except the polarizer array is placed on the wedged side of the wedge. c) A polarimeter made with a 2×2 lens array, a 2×2 polarizer array, and a 2×2 PD array, in which the lens array divides the input beams into four sub-beams to focus them into four different PDs on the PD array. The 2×2 polarizer array can be placed either behind the lens array or right in front of the PD array to detect light with different polarizations. d) A polarimeter made with a collimator, a pair of cylindrical lenses, a 1×4 lens array, a 1×4 polarizer array, and a 1×4 PD array. The light beam from the fiber collimator is expanded linearly by the cylindrical lens pair and is then focused by a 1×4 lens array onto four different PDs on the 1×4 PD array after passing through the 1×4 polarizer array. The SOP of the light can be obtained by the detected photocurrents Iᵢ (i=1,2,3,4).

FIGS. 4A-4B show examples of two different polarimeter configurations to be fabricated with photonic integrated circuit. a) a 4×4 MMI based polarimeter: a polarization splitting rotator (PSR) splits the input light into two polarizations and rotates the TM mode into a corresponding TE mode. Each of the two beams has about ⅓ power coupled out for measuring the powers of the two polarizations using PDx and PDy. The remaining light of the two beams then enter port 1 and port 3 of the 4×4 MMI to be split into 4 beams to be detected by PD1, PD2, PD3, and PD4. Finally, the SOP and DOP information can be extracted by using the six detected photocurrents. b) a 90° Hybrid based polarimeter, which is similar in construction as the 4×4 MMI based polarimeter, except that the 4×4 MMI is replaced by a 90° Hybrid. The inset below shows the construction of the 90° Hybrid, in which C1, C2, C3 and C4 are couplers with a coupling ratio around 50%.

FIG. 5 shows an example of a photonic integrated DAS interrogator for obtaining the sensing signal from the fiber using a high speed polarimeter. The configuration is similar to that of FIGS. 1A-1B, except that all or most of the functional components are on a PIC chip, with only the sensing fiber and optical circulator are outside of the chip. Laser light from a laser is first converted into optical pulses by the modulator/switch and the SOA or driven directly electrical pulses before output to the sensing fiber via a spot size converter (SSC). The backscattered and reflected light from the sensing fiber is separated by an optical circulator from the output light before entering the input waveguide with another SSC via a short length of single mode (SM) fiber, which then propagates in a waveguide supporting both TE and TM modes. The state of polarization (SOP) of the light is then then measured with a PIC polarimter described in FIGS. 4A-4B. An optional SOA and BPF can be used to amplify the backscattered light and filter out the excess spontaneous emission noise of the optical amplifier. A disturbance at a location z in the fiber will cause the SOP to change rapidly, which can be detected by the polarimeter at a time T_{z}=2z/(nc), where n is the refractive index of the fiber. The location of the distance can then be determined as z=ncT_{z}/2.

FIG. 6 Illustration of a photonic integrated DAS interrogator for obtaining the sensing signal from the fiber using a high speed polarimter with coherent amplification. The configuration is similar to that of FIG. 5, except that a small portion of light from the laser is directly injected into the polarimeter to interfere with the back scattered light from the fiber. Such a coherent amplification can greatly enhance the back scattered light from the fiber and increase measurement sensitivity.

FIG. 7 is an illustration of the polarimeter with ports supporting coherent amplification described in FIG. 6, for enhancing the measurement sensitivity.

### DETAILED DESCRIPTION

A distributed acoustic sensing (DAS) system can be achieved by an optical sensing system based on a phase sensitive optical time domain reflectometer (OTDR) to detect local phase disturbances at various locations along a sensing fiber caused by an acoustic wave or a vibration, with the distance information determined by the time-of-flight of the optical pulse backscattered by the Rayleigh backscattering (RBS) inside the sensing fiber. The DAS system can be configured to include a sensing fiber, an interrogator, and a data processing unit.

A DAS system may be implemented in various configurations to extract the local phase disturbances caused by vibration or acoustic wave. For example, a DAS system may be designed to interfere the backscattered light from the sensing fiber with reference light from the laser light source that produces both the sensing light to the sensing fiber and the reference light. Under this design, the coherent length of the laser light source to be at least twice the detection range due to the reflectometer nature of the design. Another example of a DAS system design is to interfere two backscattered light signals from two different locations of the sensing fiber that are separated by a distance of a certain designed length (e.g., a few meters in some applications). Because the backscattered light signals from the two locations along the sensing fiber are extremely low, the phase noise of the laser light source is usually required to be extremely low to allow the signal strength of the interference signal to be above the system noise floor primarily determined by the laser phase noise. Therefore, in both of the above examples of DAS system designs, the laser light source is required to exhibit an extremely narrow length width, which may be, for example, on the order of kHz or less, for high sensitivity and long sensing range in certain sensing applications.

The DAS system design in this patent document is based on detecting changes or disturbances in the state of polarization (SOP) of the sensing light with optical pulses in the sensing fiber that are caused by the acoustic wave or vibrations in the sensing fiber during one pulse duration for sensing the acoustic vibrations and stresses sensed by the sensing fiber. Specifically, different polarization components of the backscattered light within one optical pulse from a common location and its neighboring locations within very short distances traveled by light within the pulse duration in the sensing fiber are measured for extracting the local disturbances caused by acoustic wave or vibration along the sensing fiber. Because the different polarization components are backscattered light from the adjacent locations within one pulse duration in the sensing fiber, there are practically no or very low relative delays between the different polarization components which interfere with one another such that the coherent length of the laser light source can be relatively short (i.e., wider laser linewidths) in comparison to the long coherence length of a laser light source used in the above two DAS system designs based on interferences of the backscattering light and the reference light, or backscattered light signals from different locations in the sensing fiber (and arriving in different times at the photodetector). Under the polarization based DAS sensing disclosed in this patent document, the linewidth requirement on the laser light source can be greatly relaxed and the cost of the laser light source can be significantly reduced. For example, the low-cost laser used in the OTDR can be directly used, which can be of single or multi longitudinal modes in some applications.

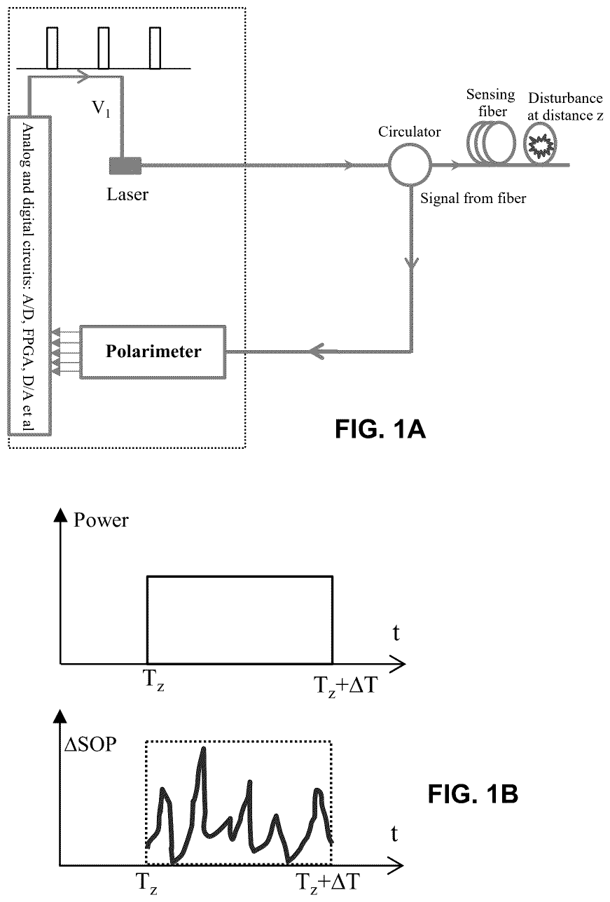

FIG. 1A illustrates an example of a first embodiment of the disclosed DAS interrogator for obtaining the sensing signal from the fiber using a high speed polarimter to measure the SOP variation during one pulse duration. A laser, such as a semiconductor laser, is used to generate laser light with optical pulses that is coupled to the sensing fiber as sensing light. The backscattered and reflected light from the sensing fiber is separated by an optical circulator from the output light before entering a high speed polarimeter. A disturbance at a location z in the sensing fiber can cause the SOP to change rapidly during the pulse duration of each optical pulse, which can be detected by the polarimeter at a time T_{z}=2nz/c, where n is the optical refractive index of the fiber, as shown in FIG. 1B. The location z at the optical reflection in the sensing fiber can be determined as z=cT_{z}/(2n).

The local SOP variation at the location z in the sensing fiber during the pulse duration can be expressed by the variations of three Stokes parameters s₁, s₂, and s₃ of the SOP, or alternatively, by the solid angle Ω variations on the Poincare Sphere:

$$Ω ( z , t ) = {cos}^{- 1} \frac{\vec{s} ( z , t ) \cdot \vec{s} ( z , t - τ )}{\vert \vec{s} ( z , t ) \vert \vert \vec{s} ( z , t - τ ) \vert} \qquad ( 1 )$$

where the Stokes vector of the SOP at the location z and time t is

$$\vec{s} ( z , t ) = {[ {s}_{1} ( z , t ) , {s}_{2} ( z , t ) , {s}_{3} ( z , t ) ]}^{T}$$

T stands for the transpose of the [s₁(z,t), s₂(z,t), s₃(z,t)], and τ is the time delay of a polarization component within that one optical pulse. Under this design, the amount of a local stress or vibration at the location Z in sensing fiber can be represented by the variations in polarizations in form of changes in the solid angle Ω or variations of three Stokes parameters s₁, s₂, and s₃ of the SOP.

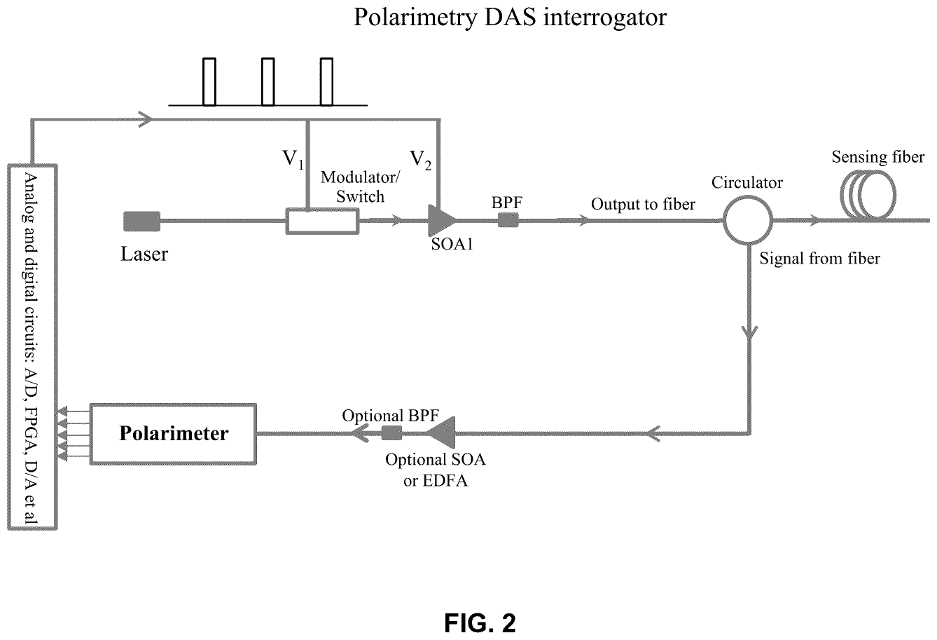

FIG. 2 illustrates an example of a second embodiment of the disclosed DAS system for extracting SOP disturbances caused by the acoustic wave or vibration in the sensing fiber using a high speed polarimter. Laser light is first converted into optical pulse by a modulator/switch and the semiconductor optical amplifier SOA before output to the sensing fiber. An optional bandpass filter (BPF) can be used to filter out the excess spontaneous emission noise of the SOA. The backscattered and reflected light from the sensing fiber is separated by an optical circulator from the output light before entering the polarimeter for detecting the SOP fluctuations caused by the acoustic wave or vibration. A disturbance at a location z in the fiber will cause the SOP to change rapidly, which can be detected by the polarimeter at a time T_{z}=2nz/c, where n is the refractive index of the fiber. The location of the distance can then be determined as z=cT_{z}/(2n). An optical amplifier, such as Er-doped fiber amplifier EDFA or a second SOA can also be used, followed by a BPF, to boost the return signal from the sensing fiber for the optical polarimetry detection.

In various DAS applications, the optical pulses may need to have a high extinction ratio (ER), e.g., an ER on the order of 50-70 dB to achieve a desired detection sensitivity. Such high ER may not be readily achieved in various implementations, including DAS systems using certain modulator/switch devices. Because the SOA can be driven with a reverse voltage to make it highly absorptive, the SOA can be used as both an optical amplifier and a high ER optical pulse generator with a high extinction ratio. Therefore, the modulator/switch can be removed and only SOA may be used to accomplish the switching function by driving the SOA with pulsed electrical signal.

Both amplitude division polarimeters and wavefront division polarimeters can be used to detect the fast SOP variations. The returned light from the sensing fiber can be split into different optical beams that are respectively processed with different optical polarization elements and detected by different optical detectors to obtain the Stokes vector elements can be measured simultaneously with multiple detector configurations. The division of the wavefront of the returned light into separate optical beams can be then respectively processed with different optical polarization elements and detected by different optical detectors to obtain the Stokes vector elements.

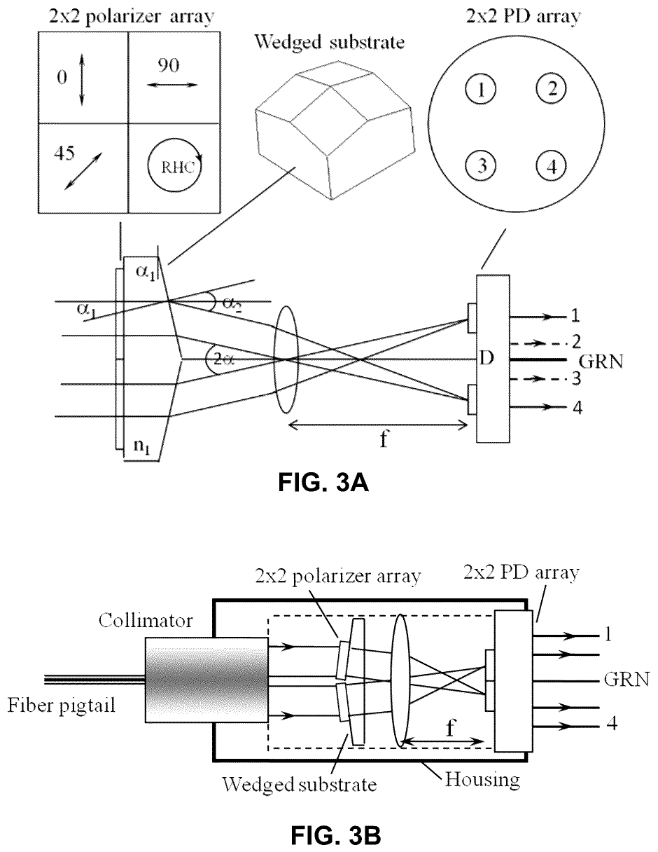

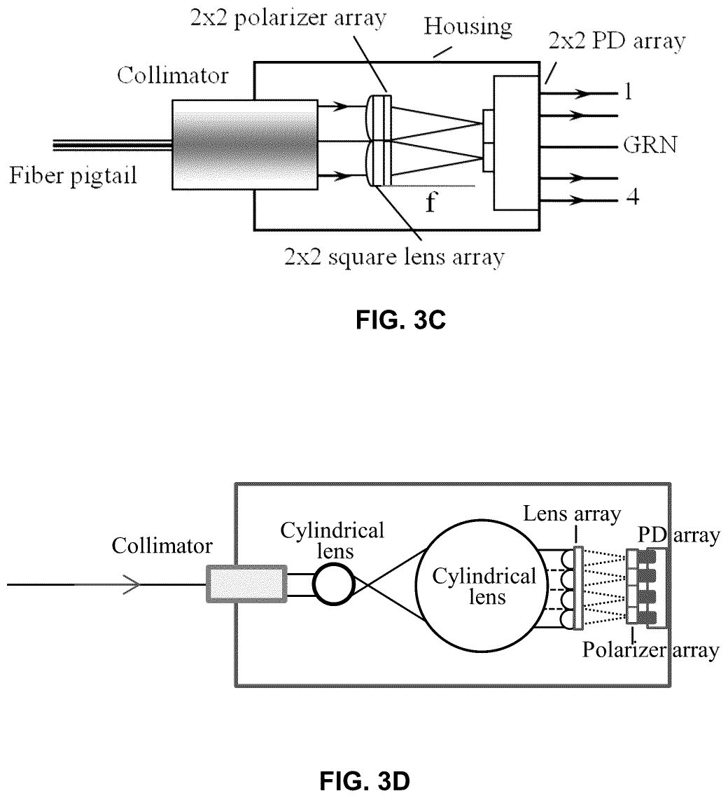

FIGS. 3A to 3D illustrate examples of four different wavefront division polarimeters made with micro-optics.

FIG. 3A shows a polarimeter made with a 2×2 polarizer array placed on the flat side of a wedged substrate, a focusing lens, and a 2×2 photodetector (PD) array. See device examples in U.S. Pat. No. 7,372,568 entitled “Low-cost polametric detector” by inventor X. Steve Yao, which is incorporated by reference as part of the disclosure of this patent document. The example polarimeter in FIG. 3A is one example of a wavefront division polarimeter for measuring optical polarization of light that includes a substrate that transmits light, a plurality of polarization elements located on the substrate, the polarization elements configured at different polarization states and spatially separated from one another to receive different portions of a common input optical beam to produce transmitted light beams in different polarization states; and a plurality of optical detectors, each of which corresponds to a respective polarization element and receives a transmitted light beam from the respective polarization element. More specifically, the 2×2 polarizer array in FIG. 3A includes three different polarizers oriented at 0°, 45°, 90° and a right-hand circular (RHC) or left hand circular (LHC) polarizer. Alternatively, one of the 0° or 90° polarizer can be replaced with a flat optical thin plate. In operation, a fiber collimator expand the input light from an optical fiber before passing through the 2×2 polarizer array to be divided into four sub-beams with different polarizations, and then being directed to four different directions by the wedged substrate. Finally, the four sub-beams are focused to different PDs on the 2×2 PD array to generate corresponding photocurrents or photo-voltages with four transimpedance amplifiers.

FIG. 3B shows a polarimeter similar to that of FIG. 3A except that the polarizer array is placed on the wedged side of the wedge.

FIG. 3C shows a polarimeter made with a 2×2 lens array, a 2×2 polarizer array, and a 2×2 PD array, in which the lens array divides the input beams into four sub-beams to focus them into four different PDs on the PD array. The 2×2 polarizer array can be placed either behind the lens array or right in front of the PD array to detect light with different polarizations.

FIG. 3D shows a polarimeter made with a collimator, a pair of cylindrical lenses, a 1×4 lens array, a 1×4 polarizer array, and a 1×4 PD array. The light beam from the fiber collimator is expanded linearly by the cylindrical lens pair and is then focused by a 1×4 lens array onto four different PDs on the 1×4 PD array after passing through the 1×4 polarizer array. The SOP of the light can be obtained by the detected photocurrents Iᵢ (i=1,2,3,4). Note that the PDs can be of PIN diode or avalanche photodiode (APD) for increased detection sensitivity. The PDs can be PIN diode or avalanche photodiode.

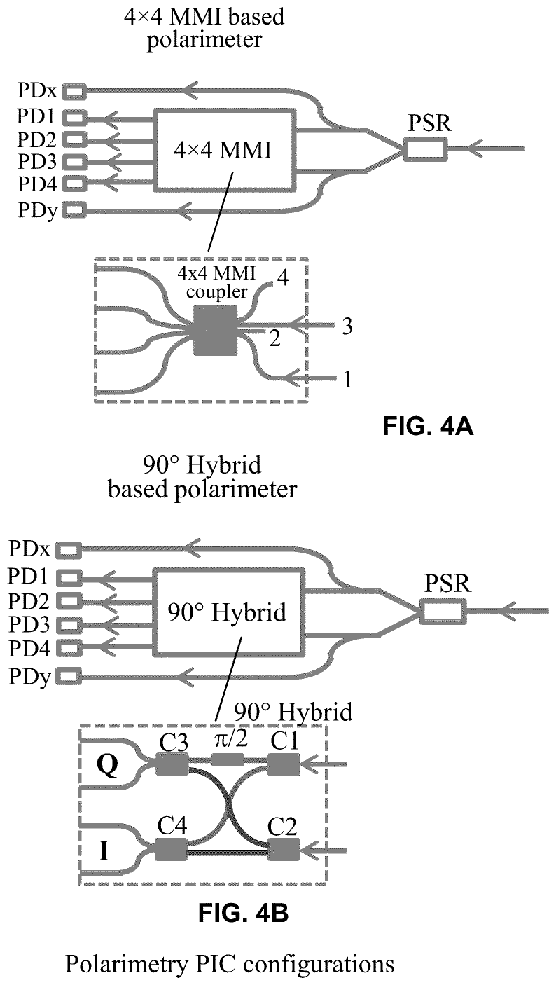

The polarimeters can also be made with integrated optics. FIGS. 4A and 4B illustrate examples of different polarimeter configurations for photonic integrated circuit (PIC) devices.

FIG. 4A shows an example of a 4×4 MMI based polarimeter in which a polarization splitting rotator (PSR) splits the input light into two orthogonal polarizations (TE and TM) and rotates the TM mode into a corresponding TE mode. Each of the two beams has about ⅓ power coupled out for measuring the powers of the two orthogonal polarizations using photodetectors PDx and PDy. The remaining light of the two beams then enter into port 1 and port 3 of the 4×4 MMI to be split into 4 beams to be detected by PD1, PD2, PD3, and PD4. Finally, the SOP and DOP information can be extracted by using the six detected photocurrents. The PDs can be PIN diode or avalanche photodiode.

FIG. 4B shows an example of a 90° hybrid based polarimeter, which is similar in construction as the 4×4 MMI based polarimeter, except that the 4×4 MMI is replaced by a 90° Hybrid. The inset below shows the construction of the 90° Hybrid, in which C1, C2, C3 and C4 are couplers with a coupling ratio around 50%. The Stokes parameters can be obtained by the detected photocurrents as:

$${S}_{0} = α ( {I}_{x} + {I}_{y} ) , {S}_{1} = α ( {I}_{x} - {I}_{y} ) , {S}_{2} = α ( {I}_{1} - {I}_{2} ) , {S}_{3} = α ( {I}_{3} - {I}_{4} ) \qquad ( 2 a )$$

$$\vec{s} = {( {s}_{1} , {s}_{2} , {s}_{3} )}^{T} , {s}_{j} = {S}_{j} / {S}_{0} ( j = 1 , 2 , 3 ) \qquad ( 2 b )$$

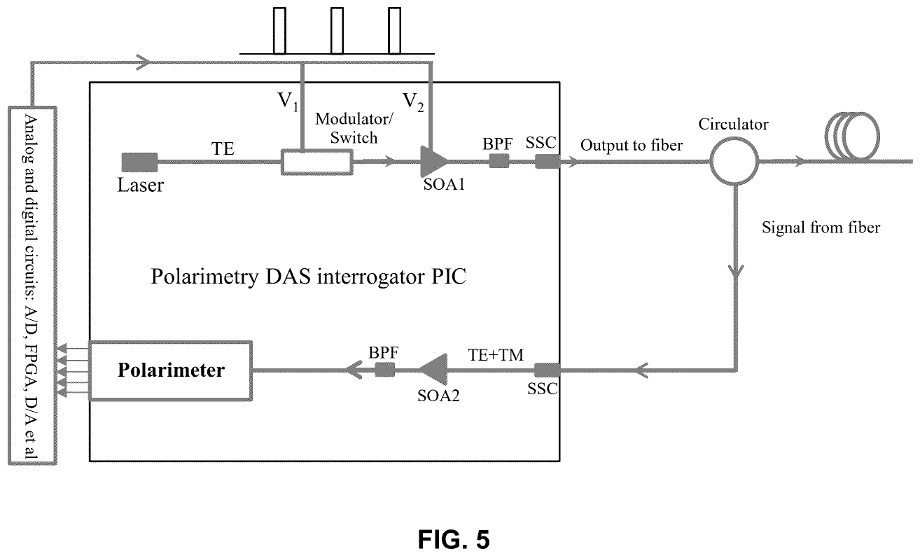

FIG. 5 illustrates a photonic integrated DAS interrogator chip for obtaining the sensing signal from the fiber using a high speed polarimeter. The configuration is similar to that of FIG. 1A-1B, except that all or most of the functional components are on a PIC chip, with only the sensing fiber and optical circulator are outside of the chip. Laser light from a narrow linewidth laser is first converted into optical pulses by the modulator/switch and the SOA before output to the sensing fiber via a spot size converter (SSC). The backscattered and reflected light from the sensing fiber is separated by an optical circulator from the output light before entering the input waveguide with another SSC via a short length of single mode (SM) fiber, which then propagates in a waveguide supporting both TE and TM modes. The state of polarization (SOP) of the light is then measured with a PIC polarimeter described in FIGS. 4A-4B. An optional SOA and BPF can be used to amplify the backscattered light and filter out the excess spontaneous emission noise of the optical amplifier. A disturbance at a location z in the fiber will cause the SOP to change rapidly, which can be detected by the polarimeter at a time T_{z}=2nz/c, where n is the refractive index of the fiber. The location of the distance can then be determined as z=cT_{z}/(2n). Similar to the case of FIG. 2, the modulator/switch can be removed and only SOA is used to accomplish the switching function by driving it with pulsed electrical signal to obtain high extinction ratio pulses.

In the disclosed embodiments above, the sensing fiber can be treated with femtosecond laser pulses or UV radiation to enhance the back scattering for increasing the detection sensitivity.

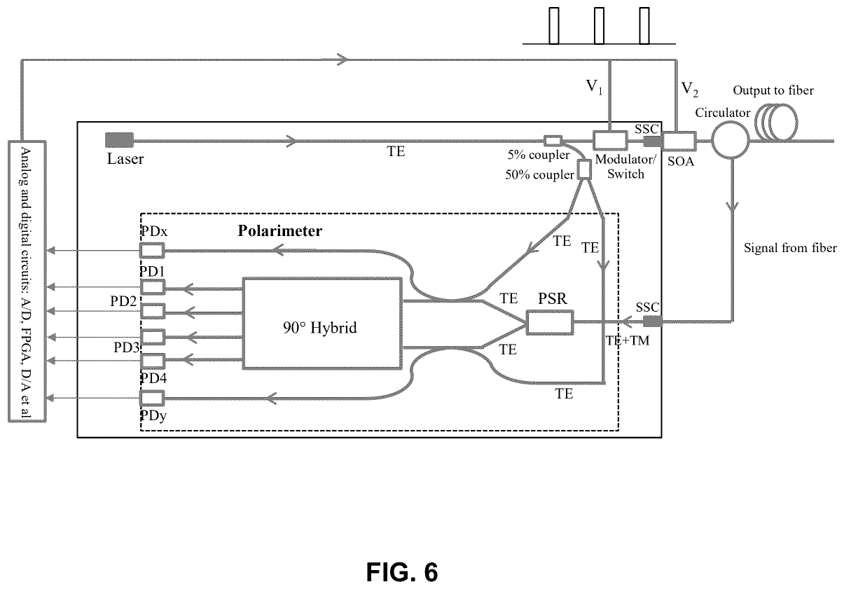

FIG. 6 is an illustration of a photonic integrated DAS interrogator for obtaining the sensing signal from the fiber using a high speed polarimeter with coherent amplification. The configuration is similar to that of FIG. 5, except that a small portion of light from the laser is directly injected into the polarimeter to interfere with the back scattered light from the fiber. Such a coherent amplification can greatly enhance the back scattered light from the fiber and increase measurement sensitivity.

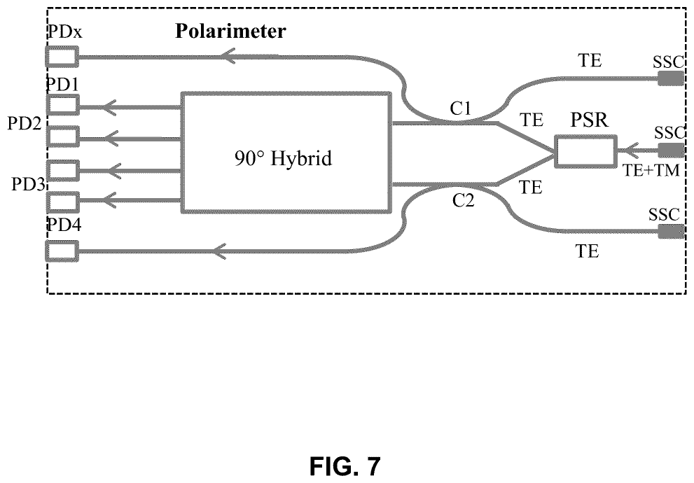

FIG. 7 is an illustration of the polarimeter with ports supporting coherent amplification described in FIG. 6, for enhancing the measurement sensitivity.

The embodiment examples of FIGS. 6 and 7 enable coherent amplification for the polarimeter to detect weak backscattered light.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Only a few implementations and examples are described and other implementations, enhancements and variations can be made based on what is described and illustrated in this patent document.

1. An optical sensing device for distributed acoustic sensing using a sensing fiber, comprising:
a laser to produce laser light;
an optical modulator located to receive the laser light from the laser to produce laser pulses for sensing local phase disturbances at various locations along the sensing fiber to cause scattering of the laser pulses to generate backscattered light; and
an optical polarimeter to receive a portion of the backscattered light returned from the sensing fiber to measure Stokes parameters of state of optical polarization of the backscattered light at various locations in the sensing fiber that carry information of variations over time in the state of optical polarization of the backscattered light indicative of the local acoustic disturbances at various locations along the sensing fiber.

2. The optical sensing device as in claim 1, wherein the optical polarimeter includes:
an optical splitter that splits the received portion of the backscattered light returned from the sensing fiber into different optical beams;
a plurality of polarization elements located to receive the different optical beams, respectively, and configured at different polarization states to produce different transmitted light beams in different polarization states; and
a plurality of optical detectors located to receive from plurality of polarization elements the different transmitted light beams in different polarization states, respectively, to produce detector output signals that that carry the information of variations over time in the state of optical polarization of the backscattered light indicative of the local phase disturbances at various locations along the sensing fiber.

3. The optical sensing device as in claim 1, wherein the optical modulator includes an electro-absorption modulator that is integrated with the laser.

4. The optical sensing device as in claim 1, wherein the optical modulator includes a Mach-Zehnder modulator.

5. The optical sensing device as in claim 1, wherein the optical modulator includes a semiconductor optical amplifier which can be driven by electrical pulses to produce amplified optical pulses.

6. The optical sensing device as in claim 5, wherein an optical bandpass filter is placed after the semiconductor optical amplifier.

7. The optical sensing device as in claim 1, wherein the optical modulator includes a Mach-Zehnder modulator combined with a semiconductor optical amplifier.

8. The optical sensing device as in claim 1, wherein the laser is a type that is directly modulated by electrical pulses to output optical pulses.

9. The optical sensing device as in claim 1, further comprising an optical amplifier and a bandpass optical filter that are placed before the polarimeter.

10. The optical sensing device as in claim 1, wherein the polarimeter is an integrated photonic device which includes
(1) an input optical waveguide that supports both TE and TM modes to receive input light,
(2) a polarization splitter that splits the input light from the input optical waveguide into TE light in a TE polarization and TM light in a TM polarization,
(3) a first waveguide to receive the TE light in the TE polarization,
(4) a polarization rotator placed in a path of the TM light in the TM polarization to rotate the TM polarization into the TE polarization,
(5) a second waveguide to receive the light in the TE polarization produced by the polarization rotator,
(6) a first photodetector to receive a portion of light from the first waveguide to produce a first detector signal,
(7) a second photodetector to receive a portion of light from the second waveguide to produce a second detector signal, and
(8) a coherent receiver that includes third, fourth, fifth and sixth photodetectors to produce, respectively, third, fourth, fifth and sixth detector signals,
wherein the first, second, third, fourth, fifth and sixth detector signals include information on Stokes parameters of polarization fluctuations caused by acoustic or vibration disturbances in the sensing fiber.

11. The optical sensing device as in claim 1, wherein the sensing fiber is treatable with femtosecond laser pulses or UV radiation to enhance the backscattering for increasing detection sensitivity.
